(19) United States
(12) Patent Application Publication
(10) Pub. No.: US 2018/0219301 A1
(43) Pub. Date: Aug. 2, 2018

(54) WIDE BAND ARRAY ANTENNA

(71) Applicant: The University of Manchester, Manchester (GB)

(72) Inventors: Anthony Keith BROWN, Manchester (GB); Yongwei ZHANG, Manchester (GB)

(21) Appl. No.: 15/748,046

(22) PCT Filed: Jul. 28, 2016
(86) PCT No.: PCT/GB2016/052319

§ 371 Date: Jan. 26, 2018

(30) Foreign Application Priority Data
Jul. 29, 2015 (GB) 1513360.6

(51) Int. Cl. H01Q 21/24; H01Q 21/06; H01Q 7/00

(52) U.S. Cl. CPC H01Q 21/24; H01Q 7/00; H01Q 21/061

(57) ABSTRACT

The invention provides an antenna array including an array of unit cells, each unit cell including two annular elements of a first type and two annular elements of a second type wherein in each unit cell: the elements of the first type comprise a balanced feed to produce radiation in a first polarisation direction, the elements of the second type comprise a balanced feed to produce radiation in a second polarisation direction, and each element of the first type is capacitively coupled to a further element of the first type located in an adjacent unit cell, and each element of the second type is capacitively coupled to a further element of the second type located in an adjacent unit cell.

The present invention relates to antennas of the array type and in particular to such antennas which are designed to have a wide usable frequency bandwidth.

There are a large variety of existing microwave antenna designs, including those consisting of an array of flat conductive elements which are spaced apart from a ground plane.

Wide band dual-polarised phased arrays are increasingly desired for many applications. Such arrays which include elements that present a vertical conductor to the incoming fields, often suffer from high cross polarisation. Many system functions have well defined polarisation requirements. Generally, low cross polarisation is desired across the whole bandwidth.

Mutual coupling always occurs in array antennas and it is related to the element type, the element separation in terms of wavelength and the array geometry. It is normally a particular problem in wide bandwidth arrays where grating lobes production must be avoided.

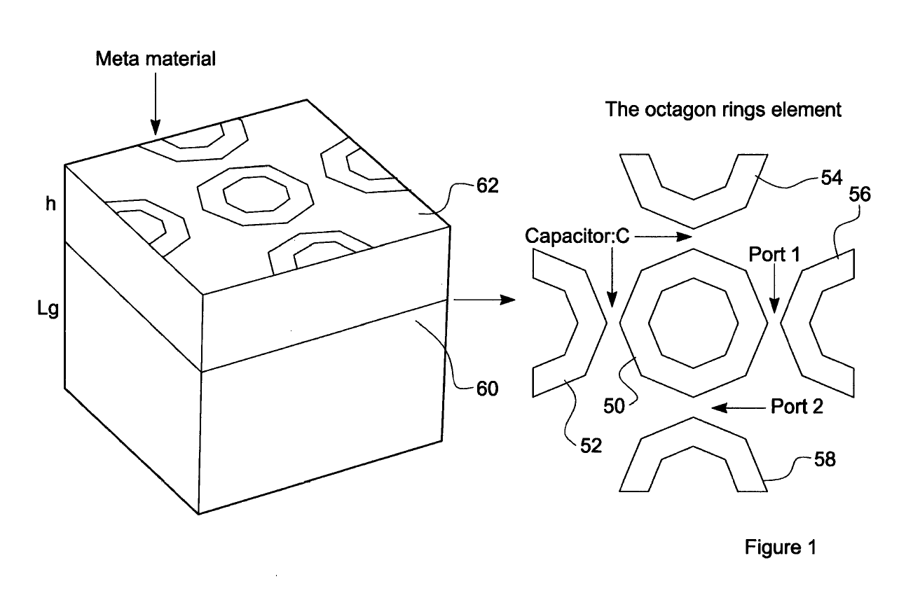

The applicant's own earlier published PCT application WO2010/112857 and UK Patent Application: GB2469075, describe a wide band array which is dual polarised. An example from that patent is shown in FIGS. 1 to 4 and described below.

In FIG. 1, a central element 50 is surrounded by four equispaced elements 52, 54, 56, 58. Central element 50 is coupled to elements 52 and 54 via respective capacitors C.

Also central element 50 forms half of two element pairs with respective elements 56 and 58. Again, these elements may be encapsulated between two layers of dielectric in a thin layer 60. The antenna design also includes a further passive conductive layer 62 spaced apart from the main antenna layer 60.

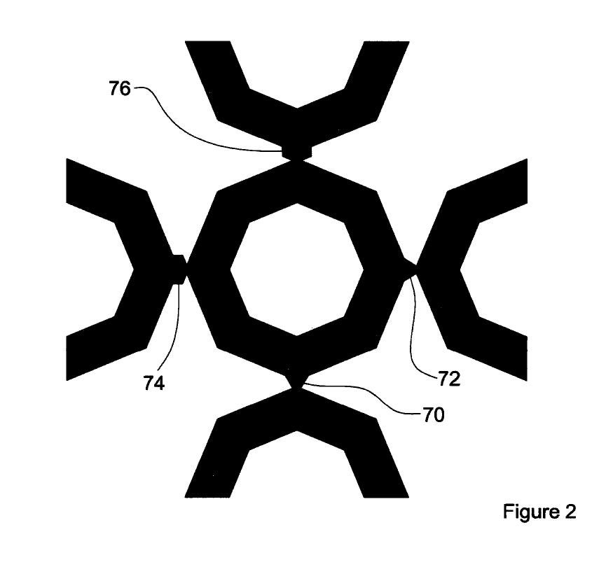

FIG. 2 illustrates the same core ‘unit cell’ element of FIG. 1. The two signal injection or excitation ports are numbered 70, 72 and the two coupling capacitors 74, 76.

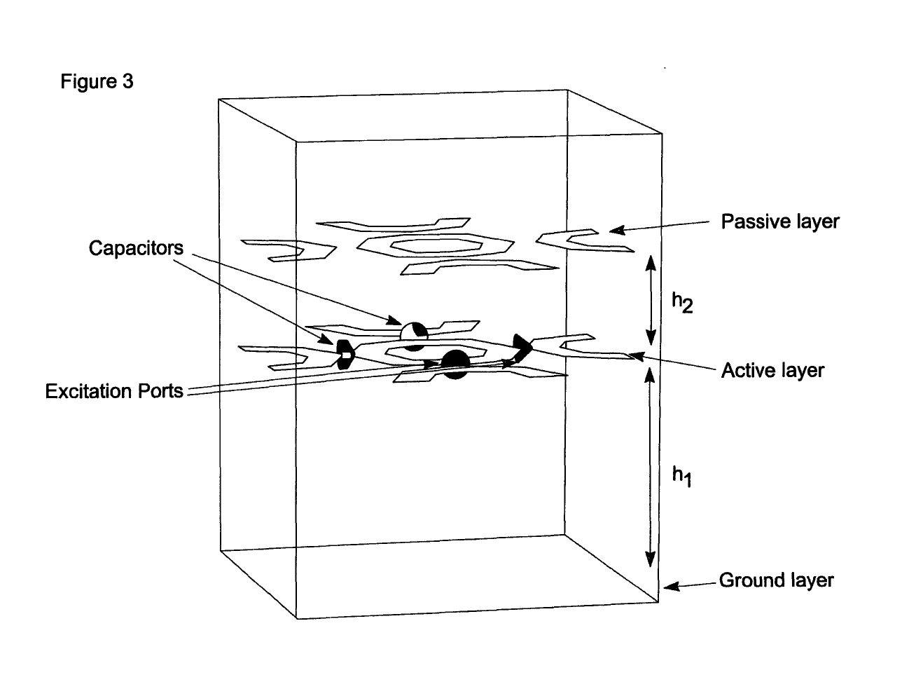

FIG. 3 is a schematic diagram showing the functional layers of an antenna block incorporating the unit cell of FIGS. 1 and 2. The active layer of FIG. 2 is spaced apart from a ground layer, and a passive layer is spaced apart from the active layer such that the passive layer is further away from the ground layer then the active layer. The passive layer is optional, as it also is in the present invention. It is a conductive layer parallel to and spaced from, the main active antenna element array layer. The passive layer is a further layer of similar conductive elements to the active array and is preferably arranged with the active array so that the elements of the two arrays are aligned.

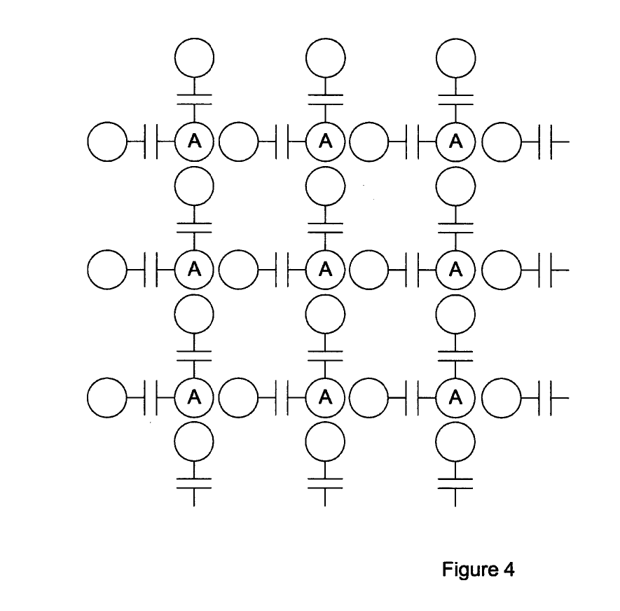

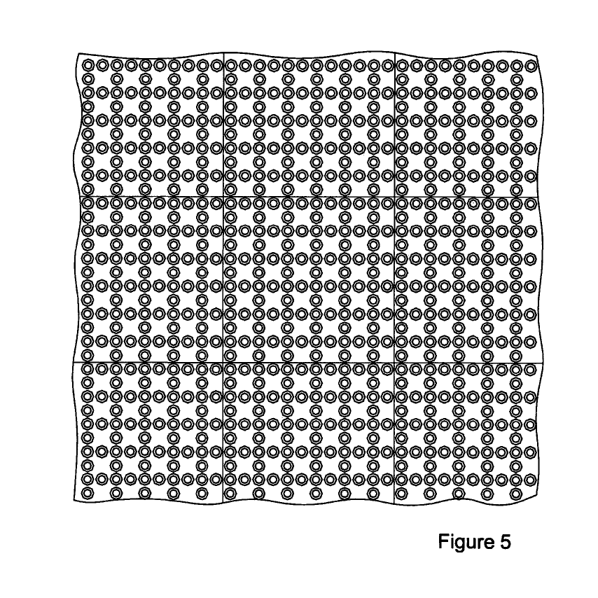

The unit cells are built up into larger arrays, illustrated in FIGS. 4 and 5. FIG. 4 shows a larger array using the type of prior art element shown in FIGS. 1-3. As can be readily seen, excluding the elements at the edges of the array, the elements not at the edges whilst physically identical can actually be categorised as being of two distinct types. There can be considered to be centre elements (labelled “A”) which, as previously described, form part of two dipoles with two other elements and in addition are capacitively coupled to two further elements. The other type of element in the array forms part of only one element pair and is capacitively coupled to only one other element. FIG. 5 shows a completed array.

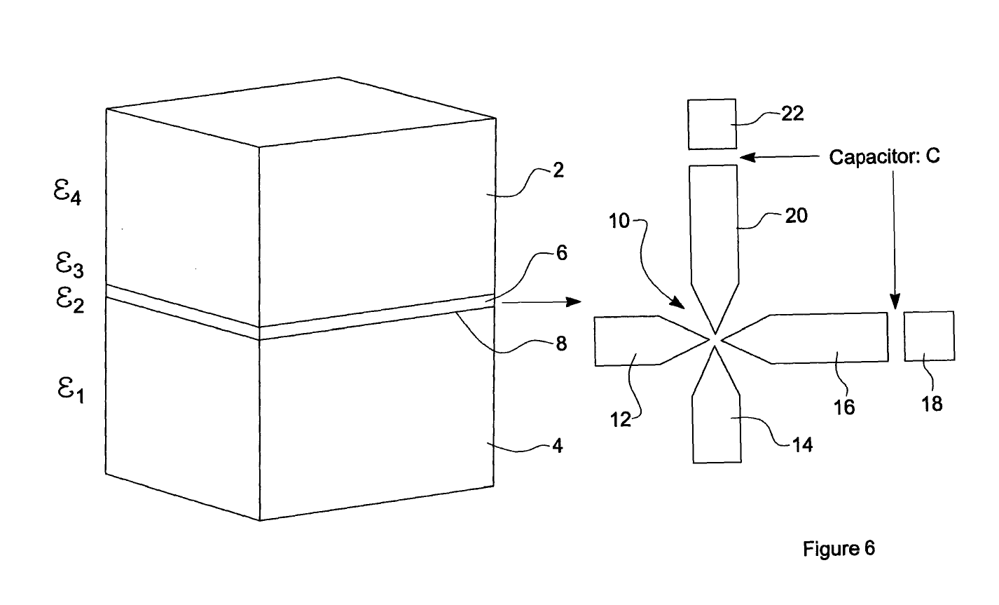

A different type of prior art antenna is the ‘Munk’ antenna, as disclosed in B. Munk, “ A wide band, low profile array of end loaded dipoles with dielectric slab compensation,” Antennas Applications Symp., pp. 149-165, 2006, use a fundamentally different approach to design the wideband array. An example is shown in FIG. 6. Mutual coupling is intentionally utilised between the array elements, and controlled by introduction of capacitance. An element consists of a part of coupled dipoles (14,20) and (12,16). The capacitance C between the ends of dipoles smoothes the radiated fields and achieves a broad bandwidth. The impedance stability over the frequency band and scan angles required is enhanced by placing dielectric layers on top of the dipole array.

The superimposed dielectric layers are important to the design of the Munk dipole array. Three or four layers of dielectric slabs are required in order to achieve a broad bandwidth. Cost becomes high for a large scale array.

One antenna type using the principles expounded by Munk is the Current Sheet Array (CSA). A CSA formed by using closely spaced dipole elements is shown in FIG. 6. The configuration here consists of two layers of dielectric material (2,6) on top of the dipole array (one part shown in FIG. 1) in addition to two thin sheets (both shown as layer 8) on both sides to embed the dipole elements (12,14,16,18,20,22) therebetween.

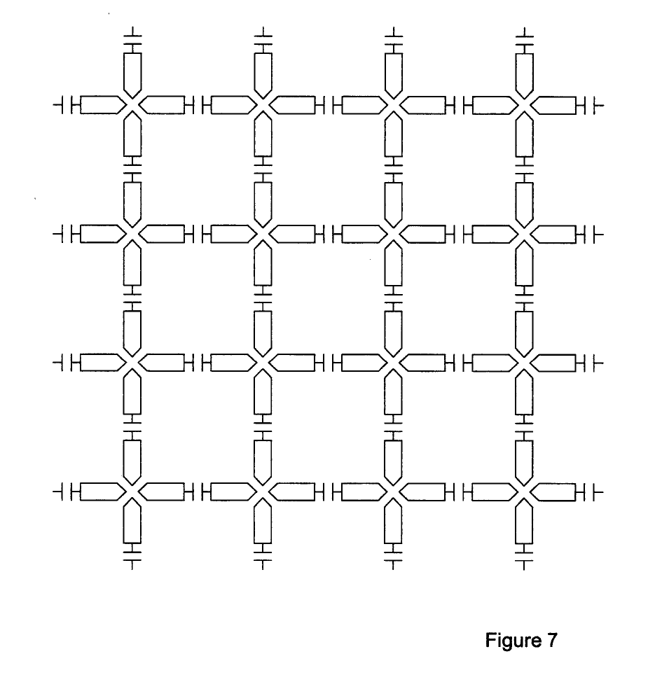

FIG. 7 shows a larger array using the type of prior art element shown in FIG. 6. As can be readily seen, each individual element of this array is identical to all of the other elements in the array (except of course for the ones at the edges of the array). Generally, each element forms part of a radiating element pair with another such element and also is capactively coupled to one such element.

The new crossed ring design effectively elongates the electric length within one element but still keeps the optimal element space for side lobes control. The structure becomes more compact in the vertical plane potentially yielding a higher efficiency. The new structure also demands a higher capacitance between the adjacent elements therefore the impedance variation between the high and low frequency points becomes minimal.

The isolation between the two polarised elements of an antenna is in general desired to be at least −30 dB for mobile communication application even lower for radio astronomy.

To address this, a further improvement is described in the applicant's own WO2015/019100. The active planes of the antennas described above with reference to FIGS. 1-5, and similarly of the present invention, can be considered to be ‘dual polarised’; that is, they are fed with signal in two directions. The directions as seen in FIGS. 1 and 2 are horizontal and vertical (both in the plane of the paper). Effectively, the antenna provides two orthogonally polarised sets of elements. In use, these are driven independently and there can be some undesirable mutual coupling between them.

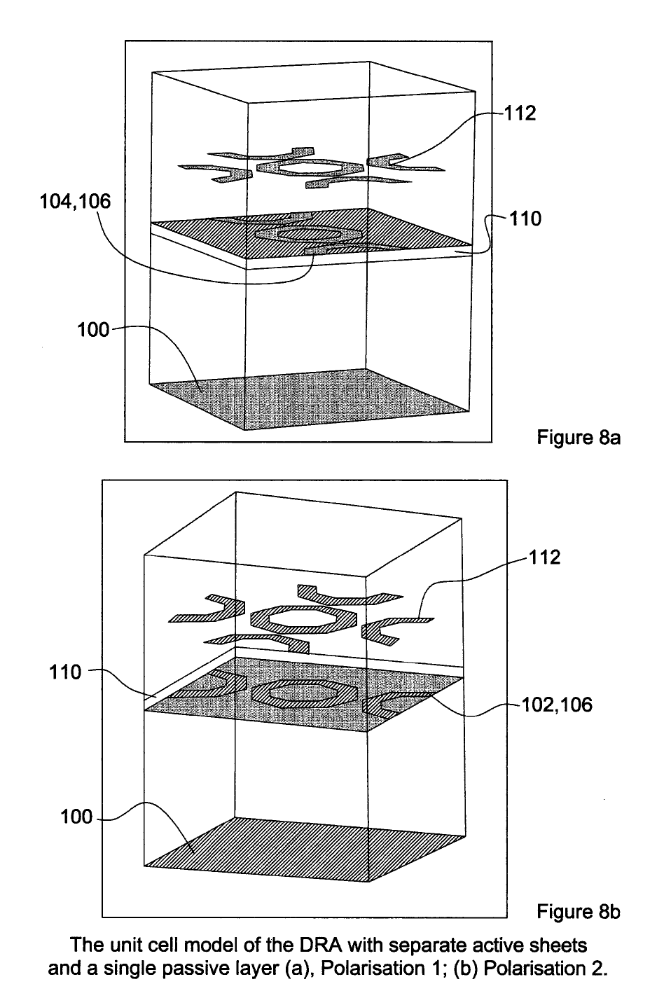

The technique of WO2015/019100 is to arrange the components of each of the two polarised elements so that the components of one element are located in a separate plane to the components of the other element. Any components which are common to both elements may be duplicated i.e. included in both planes. One example including each of the two polarised elements on separate sides of a common dielectric board. This is shown in FIGS. 8a and 8b.

FIGS. 8a and 8b show the same structure with the elements for the Polarisation 1 and Polarisation 2 are invisible in FIG. 8a and FIG. 8b respectively. The dielectric layers are omitted for clarity. A ground plane 100 is spaced from a lower 102 and upper 104 layers of the active array 106, which lower and upper layers are optionally separated by a dielectric layer 110. Lower layer 102 includes elements of the antenna which function in a first polarisation, and upper layer 104 includes elements of the antenna which function in a second polarisation.

Also shown is an optional passive reflective layer 112, located further away from the ground plane than the active antenna layers.

As each active layer is a different distance from the ground plane and the passive layer, their input impedances will be different to each other.

The present invention aims to provide a new array antenna structure which has improved performance over the prior art.

In a broad sense, the aim of the invention is to provide a different core cell structure to that of FIGS. 1-5 which provides improved isolation between the two polarised elements of an antenna, with respect to the arrangement of FIGS. 1-5, without using the split active layer arrangement of FIG. 8. Although, optionally, the split active layer arrangement could also be used with the unit cell structure of the present invention.

Accordingly, in a first aspect, the present invention provides an improved structure for a better isolation between the dual polarised elements in the aperture array.

Accordingly, there may be provided an antenna array including an array of unit cells, each unit cell including two annular elements of a first type and two annular elements of a second type wherein in each unit cell:

the elements of the first type comprise a balanced feed to produce radiation in a first polarisation direction,

the elements of the second type comprise a balanced feed to produce radiation in a second polarisation direction, and

each element of the first type is capacitively coupled to a further element of the first type located in an adjacent unit cell, and

each element of the second type is capacitively coupled to a further element of the second type located in an adjacent unit cell.

This arrangement improves separation between the radiations produced by the two balanced feeds.

The annular shape of the elements of the antenna helps improve the overall performance of the array. In particular, the array based on these elements can have a greater capacitance between adjacent elements, where that is desired. Whereas in some prior art arrays, capacitance between elements may be limited to a very low value such as 0.1 or 0.2 picofarads, with the elements of the present invention capacitances of the order of 1 picofarad may be achievable.

The term “annular” is intended to encompass shapes which are generally circular i.e. includes polygons of more than 5 sides (preferably 8) as well as true circles. In addition, the term “annular” as used here includes solid shapes as well as shapes which may have an area of non-conductive material in their centres. For example, the elements of the antenna array may be ring-shaped, preferably as an octagonal ring.

Preferably in each unit cell the first axis on which the two elements of the first type lie is perpendicular to the second axis on which the two elements of the second type lie.

Preferably in the elements of the first type in a unit cell and the elements to which they are capacitively coupled all lie on the first axis, and the elements of the second type in a unit cell and the elements to which they are capacitively coupled all lie on a second axis.

In one embodiment, the elements of the unit cells may be separated into two planes. The elements of the first type of all unit cells lie in a first plane, the elements of the second type of all unit cells lie in a second plane, and the first and second planes are spaced apart.

A preferred separation between the first and second planes of the antenna array may be between 5 and 25 mm. This may vary with the operational frequency band.

A preferred separation between the first and second planes of the antenna array may be between 5 and 10 mm. This may vary with the operational frequency band.

There may be provided a second array of unit cells, the antenna array including one or more signal feeds to only the first array.

The elements of the second array of the antenna array may be arranged in two planes, wherein those elements of the second array which match the elements of the first array in the first plane lie in a third plane, and those elements of the second array which match the elements of the first array in the second plane lie in a fourth plane.

A preferred separation between the third and fourth planes of the antenna array may be between 5 and 25 mm. This may vary with the operational frequency band.

A preferred separation between the third and fourth planes of the antenna array may be between 5 and 10 mm. This may vary with the operational frequency band.

The separation between the third and fourth planes of the antenna array may be equal to the separation between the first and second planes.

The elements of the antenna array may be non-dipole in shape.

The antenna array may further include a ground plane separated from the planar element array by a layer of dielectric material.

The dielectric material of the antenna array layer may be expanded polystyrene foam.

The capacitive coupling between elements of the antenna array may be achieved by areas of those elements being interdigitated.

In some embodiments of the present invention, elements of both types have the same physical structure (as will be seen in the figures) but in the present invention the elements are arranged such that they perform the functions of one or the other of the types set out above.

Preferably the two balanced feeds are positioned perpendicularly to each other, and each feed will produce an independently linearly polarised signal. This is termed a dual-polarised antenna.

Of course in practice such antenna arrays are not infinite in size and at the edges of any array there will be additional unit cells, having elements, for example, of a third type. Again, such elements may be identical in physical structure to the elements of the first two types, but by virtue of being at the edges of the array cannot be connected in the same ways.

In some embodiments of the present invention, the capacitive coupling is provided by the inclusion of discrete capacitors. However, in alternative embodiments, the capacitive effect is achieved by interdigitating areas of the respective elements which are being coupled. Preferably the size of the areas being interdigitated and the amount of interdigitation is chosen to provide the desired level of capacitive coupling.

In a further aspect, the present invention provides a method of creating an antenna array including the step of providing unit cells having elements as previously described and arranging them as also previously described.

Preferably, in the antenna array for each unit cell the elements are spaced equally around a central point.

The antenna array optionally includes for each unit cell two low noise amplifiers, one for each balanced feed, are located around the central point, and nearer to the central point than the elements of that cell.

Preferably the two low noise amplifiers are located in a plane between the plane of the unit cells and the ground plane. Alternatively for each unit cell the two low noise amplifiers are located in the same plane as the unit cell.

Embodiments of the present invention will now be described with reference to the accompanying drawings in which:

FIG. 1 shows an example of a prior art—“Octagonal Ring antenna” from the applicant's earlier patent utilising “ring” elements which are octagonal.

FIG. 2 illustrates the unit cell of FIG. 1.

FIG. 3 is a schematic diagram showing the functional layers of an antenna block incorporating the unit cell of FIGS. 1 and 2.

FIG. 4 shows schematically how the unit cells of FIG. 2 combine to form a larger array

FIG. 5 shows an embodiment of a larger array utilising the design of FIG. 1.

FIG. 6 shows an example of a prior art Munk antenna.

FIG. 7 illustrates a larger array of the Munk antenna cells of FIG. 6.

FIGS. 8a and 8b show a split active layer embodiment. The drawing shows the unit cell of FIG. 2, but is applicable to the unit cell of the present invention.

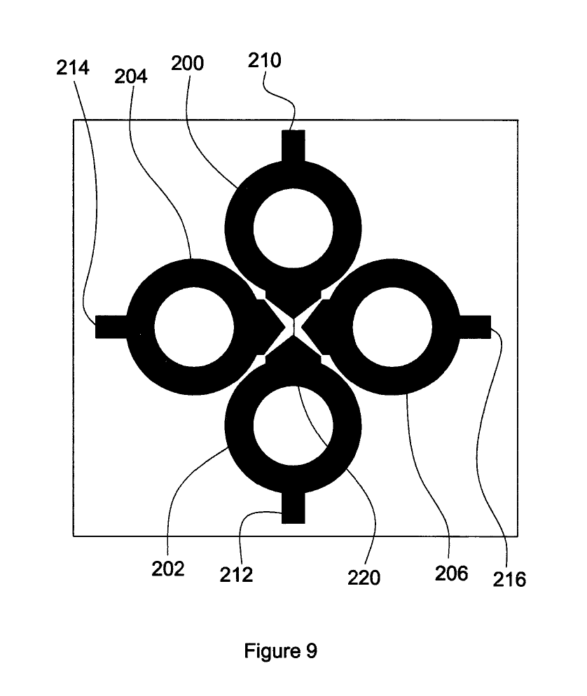

FIG. 9 shows an embodiment of a unit cell of the present invention.

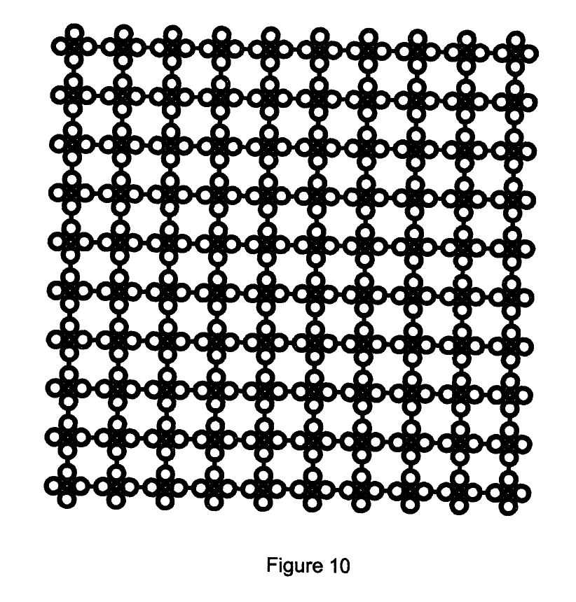

FIG. 10 shows schematically how the unit cells of FIG. 9 combine to form a larger array.

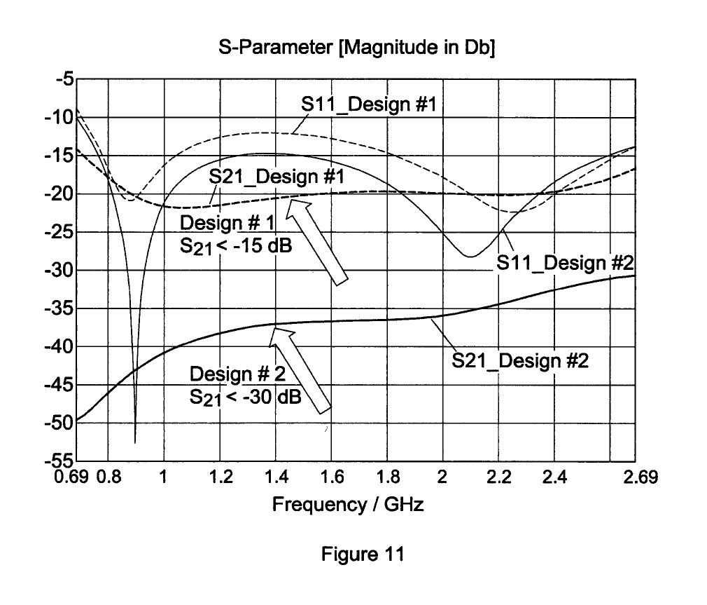

FIG. 11 shows the coupling performance of the design of FIG. 10, compared to that of FIG. 4.

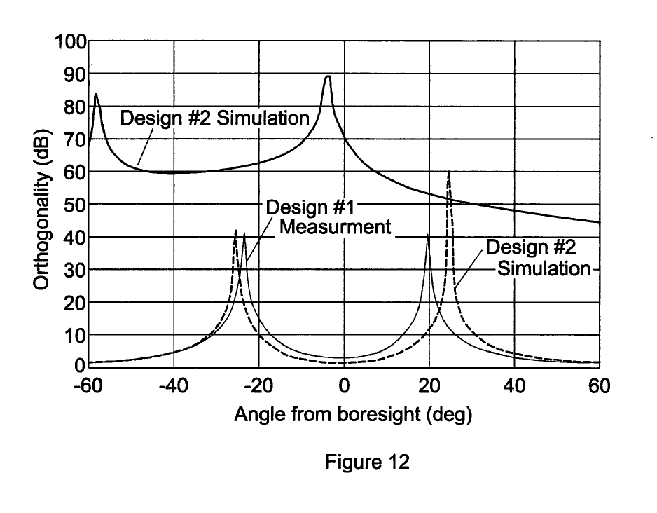

FIG. 12 shows the orthogonality performance of the design of FIG. 10, compared to that of FIG. 4

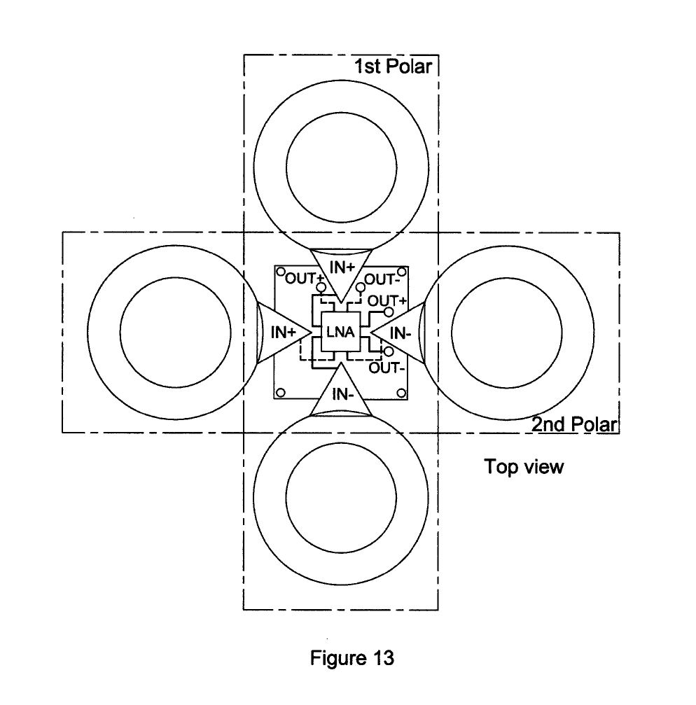

FIG. 13 shows a top view of a unit cell according to the present invention with a low noise amplifier component included.

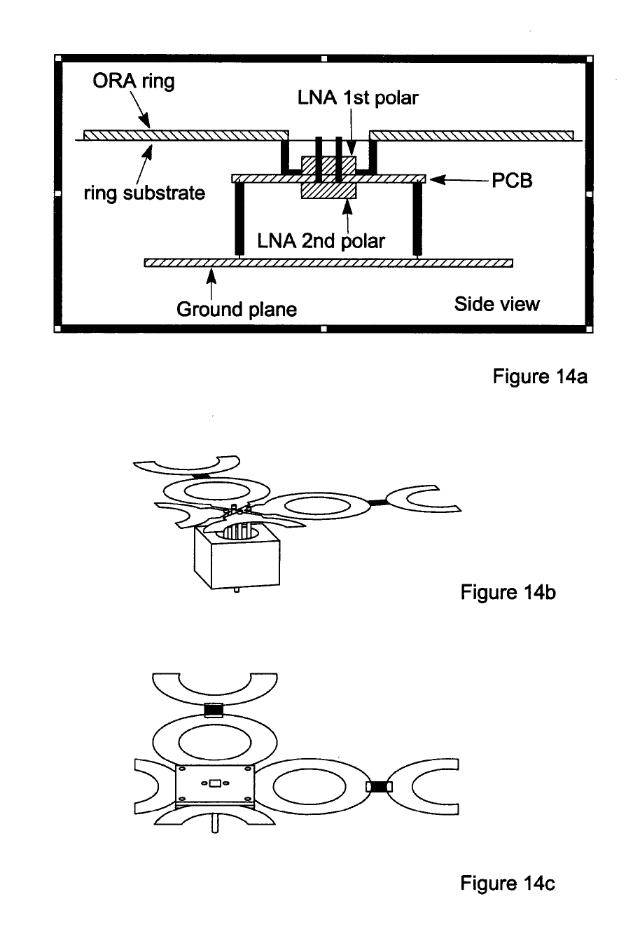

FIG. 14a is a schematic side view of FIG. 13.

FIG. 14b is a perspective side view of FIG. 14a.

FIG. 14c is a perspective view of a different embodiment, showing the low noise amplifier located in the same plane as the unit cells.

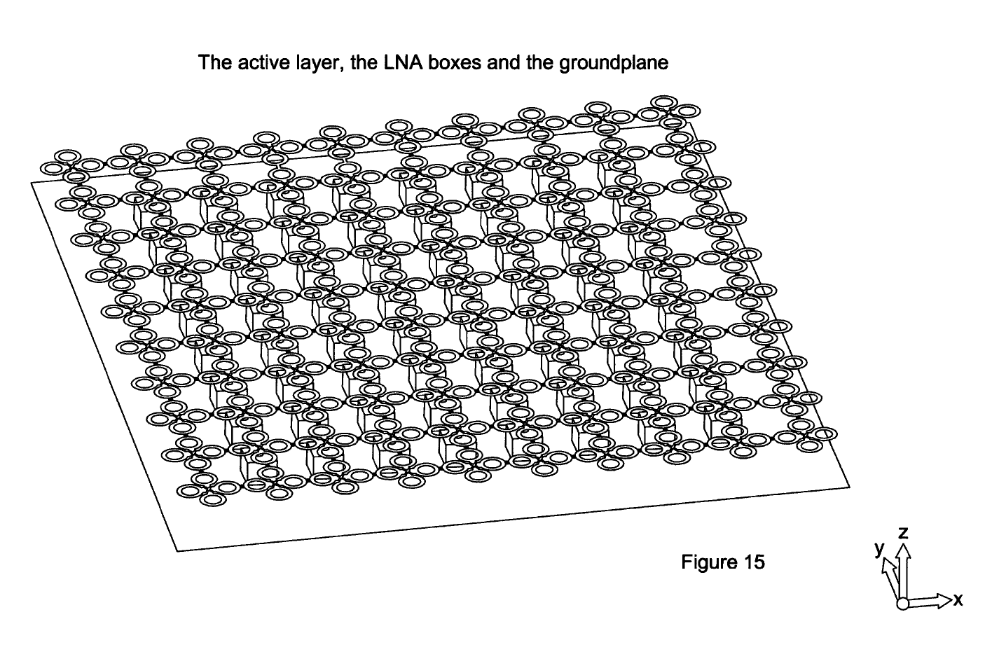

FIG. 15 is a view of a larger array of unit cells according to FIG. 13.

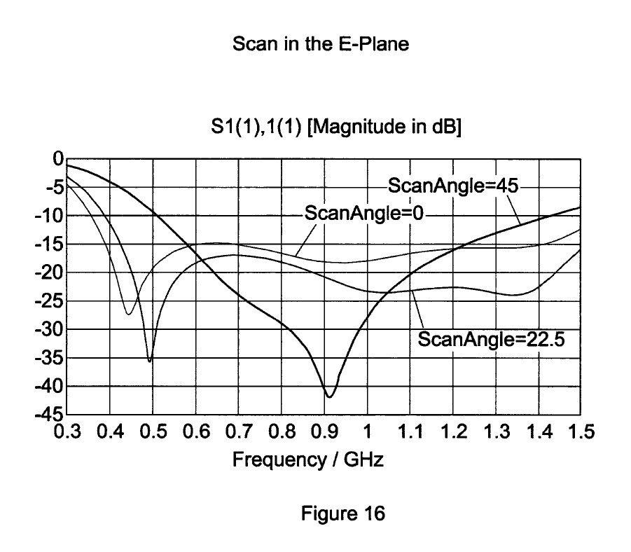

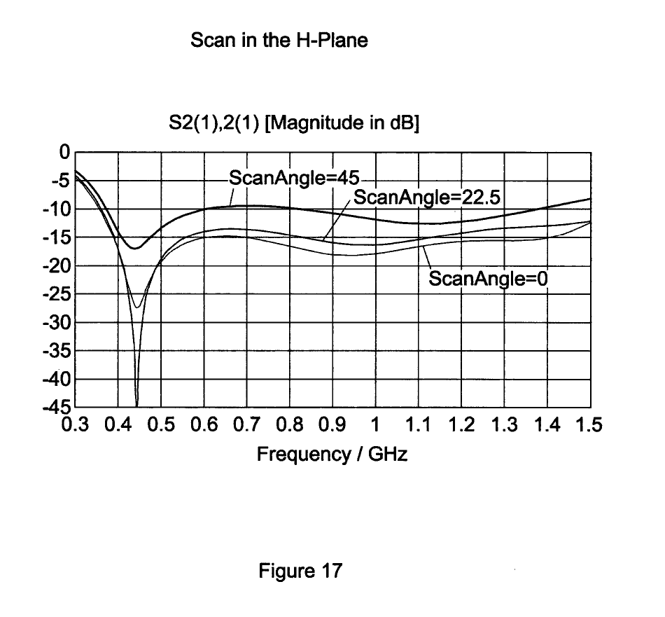

FIGS. 16 and 17 show the performance of the array of FIG. 15.

FIG. 9 shows an embodiment of a unit cell according to the present invention. The unit cell consists of four elements, in this case ring shaped elements 200, 202, 204 and 206. The four elements can be thought of as two pairs, each pair providing a single balanced feed. The first pair is elements 200 and 202, with the second pair being elements 204 and 206. As can be seen, the respective axes on which each pair of elements apply are perpendicular to each other, and the axes cross at a central point approximately in the middle of all four elements. The central point 202 is where electrical connections are made to each of the four elements so that signals can be fed to the elements. The first pair of connections (not labelled) is made to elements 200 and 202, so that they can be driven as a balance feed to produce radiation in a first polarised direction. Similarly, a second pair of connections is made to elements 204 and 206 to provide a balanced feed to those elements to produce radiation in a second polarised direction.

Each of the elements of this unit cell is capacitively coupled to a respective element of an adjacent unit cell. The capacitive coupling is shown as 210, 212, 214 and 216. Preferably the array of unit cells is aligned such that the adjacent capacitively coupled elements lie on the same axis as the elements to which they are coupled.

FIG. 10 illustrates an array of unit cells of FIG. 9. The “X” represents each signal injection point, the “O” elements represent the individual elements of the unit cells and the “−” and “|” represent capacitive coupling connections between elements of adjacent cells.

FIG. 11 illustrates the reflection coefficients and improved coupling performance of an array made with the unit cells of FIG. 9, as compared to one made with the unit cells of FIG. 1.

Similarly, FIG. 12 shows the improved orthogonality performance. The line referred to as “design #2” is an array made with the unit cells of FIG. 9 and the lines referred to as “design #1” relate to an array made with the unit cells of FIG. 1.

FIGS. 13 and 14 illustrate options for the arrangement of physical connections to the elements. In FIG. 14, the block labelled “LNA” represents a pair of low noise amplifiers. One of the low noise amplifiers is coupled to provide a signal to the first pair of elements (corresponding to elements 200 and 202 of FIG. 9). Likewise, the second low noise amplifier is coupled to provide a balanced signal to the second pair of elements (corresponding to 204 and 206 in FIG. 9). FIG. 14a then shows a side view of this arrangement, showing that the low noise amplifier block is located just below the substrate on which the antenna rings are formed. This arrangement provides a structure which is easy to manufacture and enables a very compact antenna to be formed. FIG. 14b illustrates a perspective view of FIG. 14a.

FIG. 14c illustrates a different connection arrangement. In this arrangement, the low noise amplifier block is located in substantially the same plane as the elements and so the LNA pair for each unit cell is located centrally with respect to the four elements of that unit cell. This provides a very low loss antenna arrangement.

FIGS. 16 and 17 illustrate the performance of an array according to the present invention. It indicated that the new design demonstrates an excellent impedance stability over a broad bandwidth and a wide scan angle.

Although ring shaped elements are shown, elements of other shapes e.g. circular or square or octagonal may be used instead. Also elements may be solid rather than hollow or ring-shaped.

Bulk capacitors may be soldered between the octagonal ring (or other shaped) elements. Alternatively, and preferably, capacitance is provided by interdigitating the spaced apart end portions to control the capacitive coupling between the adjacent ORA elements. The interlaced fingers can replace the bulk capacitors between the elements to provide increased capacitive coupling. For the dual-polarised ORA array with 165 mm pitch size, capacitors of 1 pF are used, for example, each capacitor can be built with 12 fingers with the length of the finger of 2.4 mm. The gap between the fingers is e.g. 0.15 mm. This is shown in FIG. 2. The unit cell configuration is based on h=70 mm, L_{g}=110 mm, sf=0.9.

The element spacing is, for example, 165 mm and the capacitance value for the bulk capacitors between the elements is 1 pF.

For a single passive reflection layer, with a separation between the two active layers of 5 mm, the reflection coefficient for two polarisations is given in FIG. 6.

As mentioned previously, an arrangement with two active layers may be used, with each active layer containing elements producing radiation of a single polarisation direction. In addition, optionally a two reflection layer solution can be introduced. Effectively, the passive (reflective) layer is separated into its two constituent polarised layers in the same way as the active layer has been split, with one lower passive layer corresponding to the lower active layer, and one upper passive layer corresponding to the upper active layer. This enables the distance between these two pairs of active and passive layers to be kept the same or similar. As a result, the corresponding passive layer rings for the two polarisations are also separated with the same distance as that of the active layer.

The present invention has been described with reference to preferred embodiments. Modifications of these embodiments, further embodiments and modifications thereof will be apparent to the skilled person and as such are within the scope of the invention.

1. An antenna array including an array of unit cells, each unit cell including two annular elements of a first type and two annular elements of a second type, wherein in each unit cell:
the elements of the first type comprise a balanced feed to produce radiation in a first polarisation direction,
the elements of the second type comprise a balanced feed to produce radiation in a second polarisation direction, and
each element of the first type is capacitively coupled to a further element of the first type located in an adjacent unit cell, and
each element of the second type is capacitively coupled to a further element of the second type located in an adjacent unit cell.

2. An antenna array according to claim 1 wherein in each unit cell of the first axis on which the two elements of the first type lie is perpendicular to the second axis on which the two elements of the second type lie.

3. An antenna array according to claim 2 wherein in the elements of the first type in a unit cell and the elements to which they are capacitively coupled all lie on a first axis, and the elements of the second type in a unit cell and the elements to which they are capacitively coupled all lie on a second axis.

4. An antenna array according to claim 1 wherein the elements are non-dipole in shape.

5. An antenna array according to claim 4 wherein the elements are circular or polygonal in shape.

6. An antenna array according to claim 5 wherein the elements have an area of non-conductive material in their centres.

7. An antenna array according to claim 6 wherein the elements are ring-shaped.

8. An antenna array according to claim 1 in which the capacitive coupling between elements is achieved by areas of those elements being interdigitated.

9. An antenna array according to claim 1 wherein the elements are arranged in a planar array.

10. An antenna array according to claim 1 in which the elements of the first type of all unit cells lie in a first plane, the elements of the second type of all unit cells lie in a second plane, and the first and second planes are spaced apart.

11. An antenna array according to claim 1 further including a second array of unit cells, the antenna array including one or more signal feeds to only the first array of unit cells.

12. An antenna array according to claim 11 in which the elements of the first type of all unit cells lie in a first plane, the elements of the second type of all unit cells lie in a second plane, and the first and second planes are spaced apart, wherein the elements of the second array are arranged in two planes, wherein those elements of the second array which match the elements of the first array in the first plane lie in a third plane, and those elements of the second array which match the elements of the first array in the second plane lie in a fourth plane.

13. An antenna array according to claim 12 wherein the separation between the third and fourth planes is equal to the separation between the first and second planes.

14. An antenna array according to claim 1 further including a ground plane separated from the unit cells by a layer of dielectric material.

15. An antenna array according to claim 14 wherein the dielectric material layer is expanded polystyrene foam.

16. An antenna array according to claim 1 wherein for each unit cell the elements are spaced equally around a central point.

17. An antenna array according to claim 16 wherein for each unit cell two low noise amplifiers, one for each balanced feed, are located around the central point, and nearer to the central point than the elements of that cell.

18. An antenna array according to claim 17 further including a ground plane separated from the unit cells by a layer of dielectric material, wherein for each unit cell the two low noise amplifiers are located in a plane between the plane of the unit cells and the ground plane.

19. An antenna array according to claim 17 wherein for each unit cell the two low noise amplifiers are located in the same plane as the unit cell.
